(19) United States
(12) Patent Application Publication
(10) Pub. No.: US 2024/0025410 A1
(43) Pub. Date: Jan. 25, 2024

(54) HYBRID ELECTRIC VEHICLE AND METHOD FOR CONTROLLING CREEP TORQUE THEREFOR

(71) Applicants: HYUNDAI MOTOR COMPANY, Seoul (KR); KIA CORPORATION, Seoul (KR)

(72) Inventors: Hoon Han, Hwaseong-si (KR); Seo Ho Lee, Siheung-si (KR); Kwon Chae Chung, Seoul (KR); Han Nah Song, Daejeon (KR)

(73) Assignees: HYUNDAI MOTOR COMPANY, Seoul (KR); KIA CORPORATION, Seoul (KR)

(21) Appl. No.: 18/076,075

(22) Filed: Dec. 6, 2022

(30) Foreign Application Priority Data
Jul. 19, 2022 (KR) 10-2022-0089090

(51) Int. Cl. B60W 30/18; B60W 20/15

(52) U.S. Cl. CPC B60W 30/18063; B60W 20/15; B60W 30/18127; B60W 2520/00

(57) ABSTRACT

Disclosed is a hybrid electric vehicle and a method for controlling a creep torque for the hybrid electric vehicle that includes: a first motor connected to an engine, a second motor directly connected to a transmission input terminal, and an engine clutch connected to an engine shaft and the second motor. The method for controlling a creep torque includes: determining an expected charging power that is expected when a target creep torque is generated through a regenerative braking of the second motor; discharging a battery by idling the engine with the first motor while the engine clutch is open when an expected charging power is equal to or greater than a battery charging limit power; and generating the target creep torque via the regenerative braking of the second motor.

### CROSS REFERENCE TO RELATED APPLICATION

The present application claims priority to Korean Patent Application No. 10-2022-0089090, filed on Jul. 19, 2022, the entire contents of which are incorporated herein for all purposes by reference.

### BACKGROUND

### Field of the Present Disclosure

The present disclosure relates to a hybrid electric vehicle and a method for controlling creep torque therefor, capable of realizing a creep feeling in a situation where battery charging is limited.

### Description of the Related Art

In general vehicles having an internal combustion engine, the torque applied to the drive shaft in a state where an accelerator pedal sensor (APS) pedal and a brake pedal sensor (BPS) pedal are not operated may be referred to as coasting torque. In the general internal combustion engine vehicles, when any pedal (e.g., APS or BPS) is not operated, the idle torque of the engine is transmitted to the drive shaft by a torque converter and a transmission. It is referred to as a creep torque.

While such creep torque is transmitted to the drive shaft when there is no pedal operation, a driving load according to the speed of the vehicle acts in a counter direction of the creep torque. Thus, the sum of the creep torque and the driving load becomes a total load of the vehicle. It is described with reference to FIG. 1.

FIG. 1 is a graph showing an example of the relationship between a torque and a speed of a vehicle.

Referring to FIG. 1, the transmission is generally in the low stage when the speed of the vehicle is low. Therefore, when the idle speed in RPM of the engine is lower than the speed of the transmission input terminal, the idle torque of the engine is transmitted so that the vehicle travels forward by the creep torque.

Meanwhile, as interest in the environment heightened, there has been several research on electrified vehicles such as the hybrid electric vehicle (HEV), the electric vehicle (EV), and the like.

Such electrified vehicles have no engine, or the electrified vehicles may have an engine but the engine is not always turned on. Thus, the creep torque by the engine is not produced. However, in order to implement the general characteristics of the internal combustion engine, the electrified vehicles have a motor so as to produce the creep torque. Accordingly, in the vehicle having an electric motor, similarly to FIG. 1, at a low speed, a forward torque due to idle force of the internal combustion engine and the torque multiplication effect of the torque converter is simulated, and in the high speed, a reverse torque by the drag of the engine where fuel injection is stopped is simulated. As such, the region where the forward torque is simulated may be referred to as a creep region, and a region where the reverse torque is simulated may be referred to as a coasting region. Here, the reverse torque may be implemented as regenerative braking.

In the electrified vehicle, by operating the conventional hydraulic friction brake and the motor as a generator during braking, the kinetic energy of the vehicle may be converted into electrical energy, and such braking is called regenerative braking.

In a general parallel type (for example, transmission mounted electric drive or TMED) hybrid electric vehicle, the kinetic energy is used to charge a battery by applying the reverse torque through regenerative braking of the drive motor in the middle-speed and high-speed periods to realize a decelerating (creep) feeling of the vehicle. However, when the battery charging is limited due to environmental or physical factor, it is general to realize the creep feeling using the engine as the reverse torque may not be applied through the regenerative braking of the drive motor. It is described with reference to FIG. 2.

FIG. 2 is a graph showing an operation process of an engine brake mode realizing a creep feeling using an engine friction torque when a battery charging is limited in general hybrid electric vehicles.

As shown in FIG. 2, when there is a charging limitation while the creep torque using drive motor is being outputted, the motor may not apply the reverse torque. Thus, a pushing feeling occurs as the reverse torque disappears, and there may be a control that uses a friction torque of the engine by means of the source of the reverse torque. In this case, if the engine was already stopped, the engine clutch between the engine and the drive motor may be opened, so the engine clutch needs to be engaged in order to transmit the friction torque of the engine to the drive shaft. However, for the engine clutch to be engaged, the speed of the engine and drive motor need to be similar to each other. For the speed synchronization, firstly, after cranking the engine, the engine rotation needs to be controlled to match the speed of the motor. Accordingly, there may be a delay to transmit the friction torque of the engine to the drive shaft. In addition, since the source of the reverse torque is only the friction torque of the engine, and the friction torque of the engine has a limit in its magnitude, and thus there is a difference from the target creep torque. Therefore, there is a problem in that a shift difference feeling while driving arouses as the creep feeling changes. In addition, there is a problem in that the fuel may be consumed as the engine starts.

The statements in this BACKGROUND section merely provide background information related to the present disclosure and may not constitute prior art.

### SUMMARY OF THE PRESENT DISCLOSURE

The present disclosure provides a hybrid electric vehicle and a method for controlling the hybrid electric vehicle to realize a creep torque freely within output characteristics of motor and a friction torque of engine characteristics.

Technical objects to be achieved by the present disclosure are not limited to the technical objects described above, and other technical objects not described should be clearly understood by those having ordinary skill in the art to which the present disclosure pertains.

To accomplish the above objects, according to one aspect of the present disclosure, a method for controlling a creep torque of a hybrid electric vehicle is provided. In particular, the hybrid electric vehicle includes: a first motor connected to an engine, a second motor directly connected to a transmission input terminal, and an engine clutch connected to an engine shaft and the second motor. The method comprises: determining, by a controller of the hybrid electric vehicle, an expected charging power that is expected to occur when a target creep torque is generated via a regenerative braking of the second motor; discharging a battery by idling the engine with the first motor while the engine clutch is open when the expected charging power is equal to or greater than a battery charging limit power; and generating the target creep torque through the regenerative braking of the second motor.

In one embodiment, when the expected charging power is less than the charging limit power, the idling of the engine may not be performed through the first motor.

In another embodiment, the battery may be discharged by the first motor idling the engine in a state where fuel injection of the engine is prohibited.

In another embodiment, discharging the battery may include determining an operating point of the first motor for the idling of the engine when the expected charging power is equal to or greater than the battery charging limit power.

In another embodiment, determining the operating point of the first motor may including determining the operating point of the first motor to consume the power by the first motor, and the power consumed by the first motor is equal to a difference between the expected charging power and the battery charging limit power.

In another embodiment, the target creep torque may be determined based on a speed of the vehicle in a state where there is no pedal operation.

In addition, a hybrid electric vehicle according to one embodiment of the present disclosure may include: a first motor connected to an engine; a second motor directly connected to a transmission input terminal; and an engine clutch including a first end connected to an engine shaft, and a second end connected to the second motor; and a controller that determines an expected charging power that is expected to occur when a target creep torque is generated via a regenerative braking of the second motor. In particular, the controller discharges a battery by idling the engine with the first motor while the engine clutch is open, and generates the target creep torque via the regenerative braking of the second motor.

In another embodiment, when the expected charging power is less than the charging limit power, the idling of the engine may not be performed through the first motor.

In another embodiment, the controller may control the first motor to idle the engine in a state where the fuel injection of the engine is prohibited.

In one embodiment, when the expected charging power is equal to or greater than the charging limit power, the controller may determine an operating point of the first motor for the idling of the engine.

In one embodiment, the controller may determine the operating point of the first motor to consume the power by the first motor, and the power is equal to a difference between the expected charging power and the battery charging limit power.

In one embodiment, the target creep torque may be determined based on the speed of the vehicle in a state where there is no pedal operation.

In one embodiment, the first motor may be connected to the engine shaft, pulley, and a belt.

In one embodiment, the first motor may be directly connected to the first motor.

According to various embodiments of the present disclosure aforementioned, by realizing a creep torque freely within friction torque of an engine characteristics and the output characteristics of motor, required fuel that starts engine generated when entering an engine brake mode may be saved.

In addition, a shift difference feeling of the vehicle behavior due to a creep power difference between before and after entering the engine brake mode may be eliminated.

It should be appreciated by persons having ordinary skill in the art that the effects that can be achieved with the present disclosure are not limited to what has been particularly described herein above and other advantages of the present disclosure should be more clearly understood from the following detailed description taken in conjunction with the accompanying drawings.

### BRIEF DESCRIPTION OF THE DRAWINGS

In order that the disclosure may be well understood, there will now be described various forms thereof, given by way of example, reference being made to the accompanying drawings, in which:

FIG. 1 is a graph showing an example of a relationship between a torque and a speed of a vehicle;

FIG. 2 is a graph showing an operation process of an engine brake mode realizing a creep feeling using an engine friction torque when a battery charging is limited in general hybrid electric vehicles;

FIG. 3 is a view illustrating a configuration of a powertrain of a hybrid electric vehicle according to an embodiment of the present disclosure;

FIG. 4 is a view illustrating a configuration of a control system of a hybrid electric vehicle according to an embodiment of the present disclosure;

FIG. 5 is a graph illustrating the relationship for determining an operating point of a first motor between torque and an RPM according to an embodiment of the present disclosure;

FIGS. 6 and 7 are diagrams illustrating a first motor directly connected to an engine shaft and the first motor connected to the engine shaft, pulley, and a belt, respectively; and

FIG. 8 is a flowchart showing a method for controlling a creep torque of a hybrid electric vehicle according to an embodiment of the present disclosure.

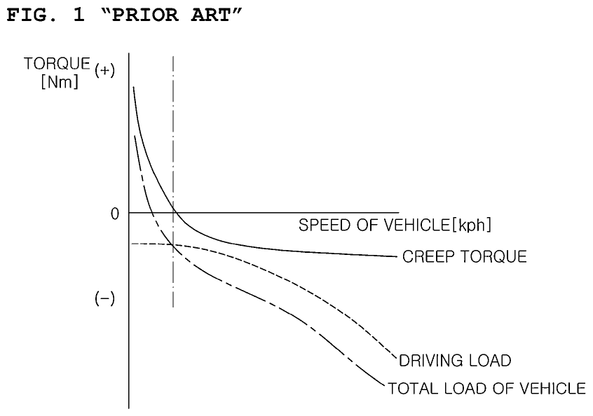

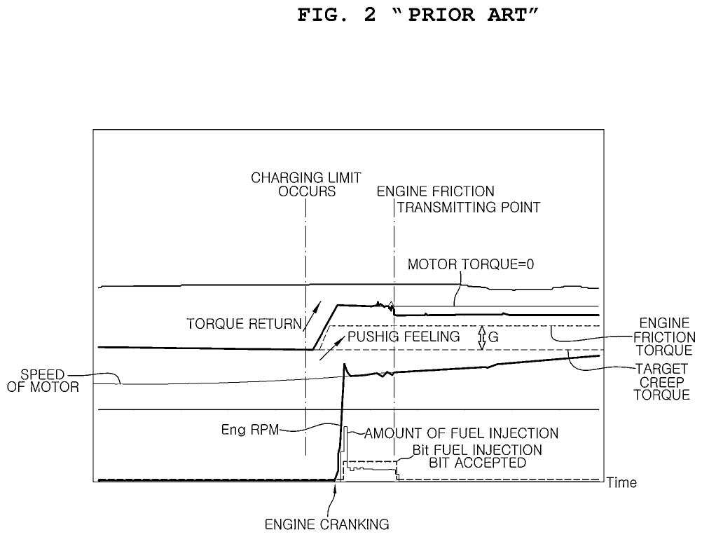

The drawings described herein are for illustration purposes only and are not intended to limit the scope of the present disclosure in any way.

### DETAILED DESCRIPTION

Hereinafter, embodiments of the present disclosure are described in greater detail with reference to the accompanying drawings. In describing the present disclosure, for ease of understanding, the same reference numerals are used to denote the same components throughout the drawings, and repetitive description on the same components has been omitted. In the following description, with respect to constituent elements used in the following description, suffixes “module” and “unit” are given in consideration of only facilitation of description and do not have meaning or functions discriminated from each other. In addition, in the following description of the embodiments disclosed in the present specification, a detailed description of known functions and configurations incorporated herein has been omitted when it may make the subject matter of the embodiments disclosed in the present specification rather unclear. In addition, the accompanying drawings are provided only for a better understanding of the embodiments disclosed in the present specification and are not intended to limit technical ideas disclosed in the present specification. Therefore, it should be understood that the accompanying drawings include all modifications, equivalents and substitutions within the scope and spirit of the present disclosure.

It should be understood that although the terms first, second, etc., may be used herein to describe various components, these components should not be limited by these terms. These terms are only used to distinguish one component from another component.

It should be understood that when a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless context clearly indicates otherwise. When a component, device, element, or the like of the present disclosure is described as having a purpose or performing an operation, function, or the like, the component, device, or element should be considered herein as being “configured to” meet that purpose or to perform that operation or function.

In the present application, it should be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

In addition, a unit or a control unit in a name such as a motor control unit (MCU) and a hybrid control unit (HCU) are terms widely used in the name of a controller that controls a vehicle-specific function and does not imply to a general function unit. For example, each controller is a communication device that communicates with other controllers or sensors to control the function that is responsible for, a memory that stores an operating system or logic commands and input/output information, and one or more processor that performs determination, calculation, decision, and the like, which is desired for controlling the function that is responsible therefor.

Prior to explaining a method for controlling a creep torque according to an embodiment of the present disclosure, descriptions are firstly made on the structure of a hybrid electric vehicle and a control system capable of applying to embodiments.

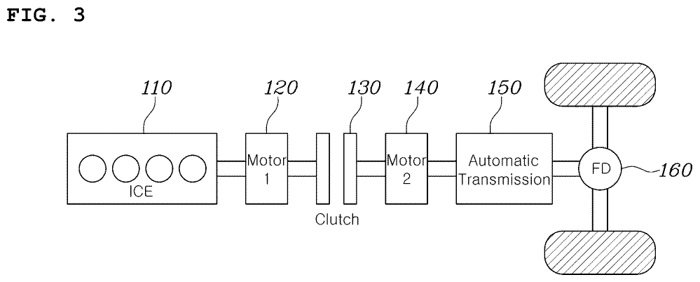

FIG. 3 is a view illustrating a configuration of a powertrain of a hybrid electric vehicle according to an embodiment of the present disclosure.

In FIG. 3, the powertrain of the hybrid electric vehicle includes two motors (e.g., a first motor 120 and a second motor 140), which are mounted between an internal combustion engine (ICE) 110 and an automatic transmission 150, and an engine clutch 130, which employs a parallel type of hybrid system. Such a parallel type of hybrid system is also called a transmission mounted electric drive (TMED) hybrid electric system since a motor 140 is always connected to an input side of the automatic transmission 150.

Here, the first motor 120 among the two motors is disposed between the engine 110 and one end of the engine clutch 130, and an engine shaft of the engine 110 and a first motor shaft of the first motor 120 are directly connected to each other to rotate together at all times.

In one embodiment, one end of a second motor shaft of the second motor 140 may be connected to the other end of the engine clutch 130, and the other end of the second motor shaft may be connected to the input terminal of the transmission 150.

The second motor 140 has an output greater than the first motor 120, and the second motor 140 may perform as a drive motor. In addition, the first motor 120 may perform as a starter motor to crank the engine 110 when the engine 110 starts. When the engine is off, the rotational energy of the engine 110 can be recovered through power generation. The power generation may be performed with the power of the engine 110 while the engine 110 is in operation.

As shown in FIG. 3, when a driver depresses an accelerator pedal after starting (for example, HEV Ready), in the hybrid electric vehicle having the powertrain, the second motor 140 may be driven using the electrical power of a battery (not shown) in a state in which the engine clutch 130 is opened. Accordingly, the power of the second motor 140 passes through the automatic transmission 150 and a final drive (FD) 160 to move a wheel (i.e., EV mode). When a vehicle is gradually accelerated and a larger driving force is required, the first motor 120 may operate to crank the engine 110.

After the engine 110 is started, when a difference in rotational speed between the engine 110 and the second motor 140 is within a predetermined range, the engine clutch 130 is engaged, and then the engine 110 and the second motor 140 may be rotated together (i.e., a transition from EV mode to HEV mode). Accordingly, through a torque blending process, the output of the second motor 140 may be decreased, and the output of the engine 110 is increased. Therefore, a driver's demand torque may be satisfied. In the HEV mode, most of the demand torque may be satisfied from the engine 110. The difference between engine torque and the demand torque may be compensated through at least one of the first motor 120 and the second motor 140. For example, when the engine 110 outputs a torque higher than the demand torque considering the efficiency of the engine 110, either the first motor 120 or the second motor 140 may generate power to the extent of the redundancy of the engine torque. When the engine torque exceeds the demand torque, at least one of the first motor 120 and the second motor 140 may output the deficit torque.

When a predetermined engine off condition, such as a decelerating vehicle, is satisfied, the engine clutch 130 may be opened, and the engine 110 may be stopped (i.e., a transition from HEV mode to EV mode). When decelerating, by using the driving force of the wheel, a battery may be recharged through the second motor 140, which is referred to as a braking energy regeneration or regenerative braking.

In general, the automatic transmission 150 may use a discrete variable transmission or a multiple-disc clutch, such as a dual clutch transmission (DCT).

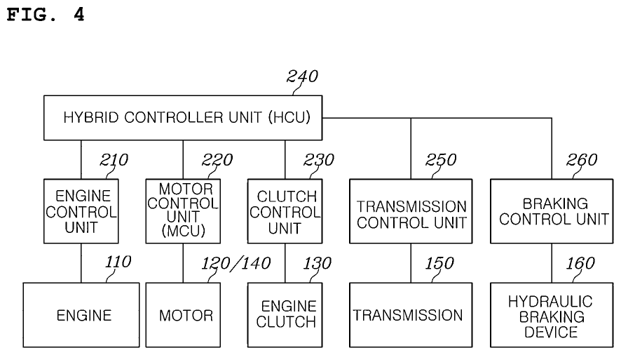

FIG. 4 is a view illustrating a configuration of a control system of a hybrid electric vehicle according to an embodiment of the present disclosure.

In FIG. 4, the engine 110 of the hybrid vehicle to which embodiments of the present disclosure can be applied may be controlled by an engine control unit 210, the first motor 120 and the second motor 140 may be controlled by a motor control unit (MCU) 220, and the engine clutch 130 may be controlled by a clutch control unit clutch control unit, respectively. Here, the engine control unit 210 is also referred to as an engine management system (EMS). In addition, the automatic transmission 150 may be controlled by a transmission control unit 250. In addition, a hydraulic braking device 160 may be controlled by a braking controller 260.

The MCU 220 transmits a pulse width modulation (PWM) control signal to a gate drive unit (not shown) based on a motor angle, phase voltage, phase current, demand torque, and the like of each of the motors 120 and 140. The gate drive unit may control an inverter (not shown) that drives each of the motors 120 and 140 accordingly.

Each control unit may be connected to a hybrid control unit (HCU) 240 that controls the overall powertrain, including a mode switching process, which is an upper-level control unit thereof, and may provide the HCU 240 with the information required to control the engine clutch when shifting gears or changing driving mode, and/or the information required to stop the engine according to the control of the HCU 240 or perform an operation according to a control signal.

For example, the HCU 240 may determine whether to perform switching between EV-HEV modes or CD-CS mode (in the case of PHEV) according to the driving state of the vehicle. To this end, the HCU determines when the engine clutch 130 is opened and performs a hydraulic control when opened. In addition, the HCU 240 may determine a state (lock-up, slip, open, etc.) of the engine clutch 130, and may control the timing of stopping the fuel injection of the engine 110. In addition, the HCU may send a torque command for controlling the torque of the first motor 120 to the MCU 220 for an engine stop control, thereby controlling the recovery of the engine rotational energy. In addition, the HCU 240 determines the state of each of the drive sources 110, 120, and 140 to satisfy the demand torque, and determines the required drive force to be shared by each of the drive sources 110, 120, and 140 according to the respective drive source, in which the respective drive source may send the torque command to the control units 210 and 220.

It should be apparent to those having ordinary skill in the art that the above-mentioned connection relationship and the function/classification of each control unit is exemplary and is non-limited by its name. For example, the HCU 240 may be implemented. The corresponding function is provided by replacing one of the other control units or may be provided in a distributed manner in two or more of the other control units. As another example, the function of the clutch control unit 230 may be implemented through the HCU 240.

In one embodiment, a braking control unit 260 may determine a total braking amount by receiving a brake pedal position sensor (BPS) value. After requesting regenerative braking to the HCU 240, the braking control unit 260 receives information on the amount of the regenerative braking performance from the HCU 240 and allows to perform the braking torque in an amount of braking deficiency amount (that is, ‘total amount of braking—the amount of regenerative braking performance’) through the hydraulic braking device 160.

It should be apparent to those having ordinary skill in the art that the aforementioned configurations of FIGS. 3 and 4 are only examples of the hybrid electric vehicle, and the hybrid electric vehicle applicable to the embodiment is not limited to such a configuration. In addition, a brake demand is a concept that includes not only the brake demand based on a brake pedal operation of the driver but also the brake control irrelevant to the driver's will such as an autonomous driving or a brake demand for an advanced driver assistance system (ADAS) intervention. However, herein, the brake demand may be assumed as a cause due to a driver's operation of the brake pedal for convenience. In addition, herein, it is assumed that the controller refers to the hybrid control unit (HCU) 240.

It should be apparent to those having ordinary skill in the art that the aforementioned configurations of FIGS. 3 and 4 are only examples of the hybrid electric vehicle, and the hybrid electric vehicle applicable to the embodiment is not limited to such a configuration.

In an embodiment of the present disclosure, when the battery charging is limited, the first motor 120 is controlled to discharge the battery so that the target creep torque is generated through the regenerative braking by the second motor 140. The case where the battery charging is limited is generally the case where the ambient temperature is extremely low, the battery is overheated, or the state of charge (SOC) is high so that the battery charging is no longer possible. In an embodiment of the present disclosure, a case where the battery charging is difficult due to the high SOC of the battery is described below.

Hereinafter, a method for controlling the first motor 120 and the second motor 140 by the controller is described.

First, in order to determine whether the reverse torque is applied in a situation where the second motor 140 is capable of applying the reverse torque, the controller may determine an expected charging power that is expected when the target creep torque is generated during the regenerative braking of the second motor 140. The expected charging power through the regenerative braking of the second motor 140 is determined because when the expected charging power is equal to or greater than the battery charging limit power, the second motor 140 may not completely generate the target creep torque.

Here, the target creep torque is the torque generated by the regenerative braking of the second motor 140 to realize the creep feeling, and the target creep torque may be determined based on the speed of the vehicle in a state where there is no pedal operation. When the engine 110 and the clutch 130 are opened, the creep torque may not be transmitted by the engine 110, and therefore, the creep torque needs to be transmitted through the regenerative braking of the second motor 140.

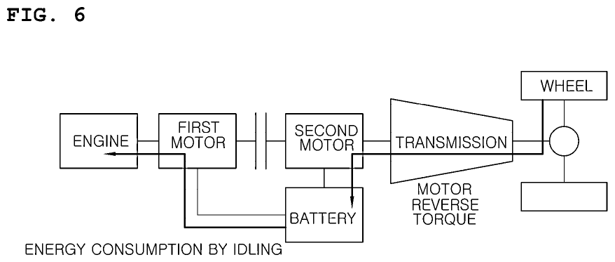

On the other hand, when the controller determines that the expected charging power is equal to or greater than the battery charging limit power, the first motor 120 is controlled to discharge the battery, thereby the second motor 140 may be in a state to generate the creep torque. As shown in FIG. 6, in the case of the engine 110 and the clutch 130 are opened, since the rotations of the engine 110 and the first motor 120 is disconnected from the transmission input shaft, the controller may discharge the battery by idling the engine 110 using the first motor 120.

Here, in the case where the first motor 120 operates to idle the engine 110, the engine control unit 210 may prohibit the fuel injection of the engine 110.

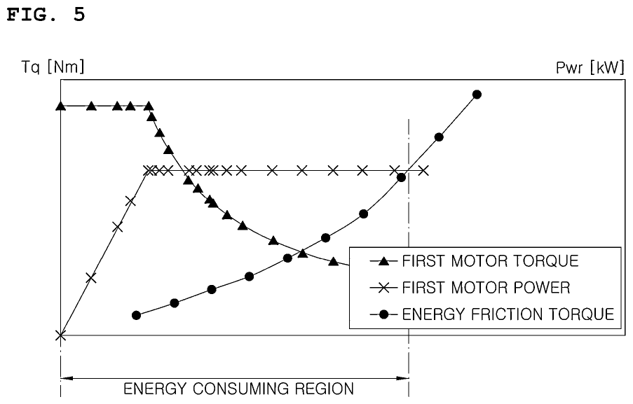

On the other hand, the controller may determine the operating point of the first motor 120 for idling the engine 110. Therefore, the controller may control to idle the engine 110 in the operating point of the first motor 120. It is described with reference to FIG. 5.

FIG. 5 is a graph showing a relationship between the friction torque and the RPM of the engine 110 for determining the operating point of the first motor 120 in the hybrid electric vehicle according to an embodiment of the present disclosure.

As shown in FIG. 5, the maximum values of torque and power of the first motor 120 differ from each other according to the operating point, and the engine friction torque tends to increase as the RPM increases. Here, the region where the friction torque of the engine is smaller than the upper limit of the first motor power may be an energy consuming region. Accordingly, the controller may determine the operating point of the first motor within the energy consuming region.

More particularly, the controller controls the first motor 120 to the point at which the power consumption of the first motor 120 that is required to idle the engine 110 may be equivalent to the difference between the expected charging power expected from the first motor 120 and the battery charging limit power. In one embodiment, when the expected charging power is equal to or greater than the battery charging limit power, the controller controls the first motor 120 to discharge the battery by idling the engine 110 by the first motor 120. When the expected charging power is less than the battery charging limit power, idling control of the engine 110 through the first motor 120 is not performed. In the latter case, it is not the situation where the battery may not be charged, and the controller is not required to control the battery to be discharged by idling the engine 110 by the first motor 120. Accordingly, even though the controller does not idle the engine 110 by the first motor 120, the target creep torque may be performed as the reverse torque of the second motor 140 is applied.

In addition, when the power equivalent to the difference between the expected charging power and the battery charging limit power is consumed in the first motor 120 to discharge the battery, the corresponding the battery discharging amount may be a minimum value of the charging power that generates in performing the creep torque for the second motor 140 to realize the creep feeling. Therefore, when the controller determines the operating point of the first motor 120 for consuming the power that is equivalent to the difference between the expected charging power and the battery charging limit power in the first motor 120, the battery discharging amount consumed by the first motor 120 may be minimized thereby controlling efficiently to realize the creep feeling.

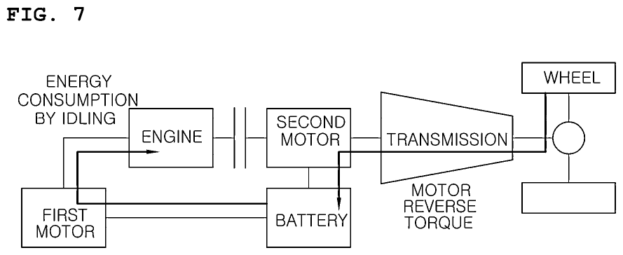

The foregoing hybrid electric vehicle described is assumed as based on the first motor 120 being directly connected to the engine 110, however, the first motor 120 may be connected to the engine 110 shaft, a pulley, or belt. It is described with reference to FIGS. 6 and 7.

FIGS. 6 and 7 are configuration diagrams showing a first motor 120 directly connected to an engine 110 shaft and the first motor 120 connected to the engine 110 shaft, pulley and a belt.

In FIGS. 6 and 7, commonly, the first motor 120 and the engine 110 are connected, the second motor 140 is directly connected to the transmission input terminal, and a first end of the engine 110 clutch 130 is connected to the engine 110 shaft, and the second end is connected to the second motor 140. In such a powertrain, in a state where the engine clutch 130 is opened, the first motor 120 may idle the engine 110, so that the creep torque control according to the embodiment is possible.

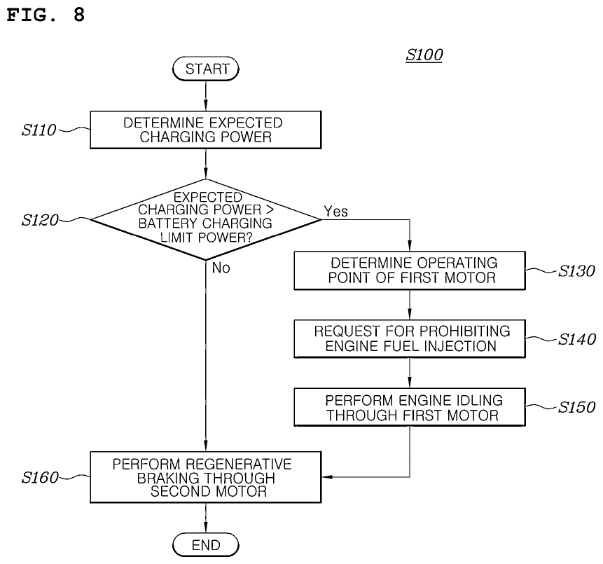

Hereinafter, a method for controlling a creep torque is described with reference to FIG. 8.

FIG. 8 is a flowchart (S100) showing a method for controlling a creep torque of a hybrid electric vehicle according to an embodiment of the present disclosure.

As shown in FIG. 8, firstly, the expected charging power may be determined when the target creep torque is generated through the regenerative braking of the second motor 140 (S110). Thereafter, it is determined whether the expected charging power is equal to or greater than the battery charging limit power (S120). When the expected charging power is equal to or greater than the battery charging limit power (YES in S120), in the state where the engine 110 clutch 130 is opened, the battery may be discharged by idling the engine 110 using the first motor 120 (S150).

To this end, the operating point for driving the first motor 120 may be determined (S130), and in order to utilize the friction torque of the engine 110, the engine 110 has to be in the off state so that the request for prohibiting the engine fuel injection may be performed (S140).

The charging power limit of the battery may be alleviated while discharging the battery by operating the first motor 120 to idle the engine 110, as a result, the target creep torque may be generated through the regenerative braking of the second motor 140 (S160).

In accordance with embodiments, by realizing a creep torque freely within friction torque of an engine characteristics and the output characteristics of motor, required fuel for starting the engine when entering an engine brake mode may be saved. In addition, a shift difference feeling of the vehicle behavior due to a creep power difference between before and after entering the engine brake mode may be eliminated.

The present disclosure mentioned in the foregoing description may be implemented as code that can be written to a computer-readable recording medium and can thus be read by a computer system. The computer-readable medium may include all kinds of recording devices in which data readable by a computer system is stored. Examples of computer-readable medium includes hard disk drive (HDD), solid state disk (SSD), silicon disk drive (SDD), ROM, RAM, CD-ROM, magnetic tape, floppy disk, optical data storage device, and the like. Therefore, the above embodiments are therefore to be construed in all aspects as illustrative and not restrictive. The scope of the present disclosure should be determined by the appended claims and their legal equivalents, not by the above description, and all changes coming within the meaning and equivalent range of the appended claims are intended to be embraced therein.

### DESCRIPTION OF REFERENCE NUMERALS

110: engine
120: first driving motor
130: engine clutch
140: second connecting gear
150: transmission
160: hydraulic braking device
210: engine control unit
220: motor control unit (MCU)
230: clutch control unit
240: hybrid controller unit (HCU)
250: transmission control unit
260: braking control unit

What is claimed is:

1. A method for controlling a creep torque of a hybrid electric vehicle, where the hybrid electric vehicle includes: a first motor connected to an engine, a second motor directly connected to a transmission input terminal, and an engine clutch connected to an engine shaft and the second motor, the method comprising:
determining, by a controller, an expected charging power that is expected when a target creep torque is generated through a regenerative braking of the second motor;
discharging a battery by idling the engine with the first motor while the engine clutch is open when the expected charging power is equal to or greater than a battery charging limit power; and
generating the target creep torque through the regenerative braking of the second motor.

2. The method of claim 1, further comprising when the expected charging power is less than the charging limit power, controlling, by the controller, the idling of the engine not to perform through the first motor.

3. The method of claim 1, wherein discharging the battery includes discharging the battery by idling the engine by the first motor, in a state where a fuel injection of the engine is prohibited.

4. The method of claim 1, wherein discharging the battery includes determining an operating point of the first motor for the idling of the engine when the expected charging power is equal to or greater than the charging limit power.

5. The method of claim 4, wherein determining the operating point of the first motor includes determining the operating point of the first motor to consume power by the first motor, and wherein the power consumed by the first motor is equal to a difference between the expected charging power and the battery charging limit power.

6. The method of claim 1, wherein the target creep torque is determined based on a speed of the vehicle in a state where there is no pedal operation.

7. A non-transitory computer-readable recording medium configured to record a program to direct a processor to perform acts of:
determining an expected charging power that is expected when a target creep torque is generated through a regenerative braking of a second motor of a hybrid electric vehicle, wherein the second motor is directly connected to a transmission input terminal of the hybrid electric vehicle, and an engine clutch of the hybrid electric vehicle is connected to an engine shaft and the second motor;
when the expected charging power is equal to or greater than a battery charging limit power, discharging a battery of the hybrid electric vehicle by idling an engine with a first motor connected to the engine while the engine clutch is open; and
generating the target creep torque through the regenerative braking of the second motor.

8. A hybrid electric vehicle comprising:
a first motor directly connected to an engine;
a second motor directly connected to a transmission input terminal;
an engine clutch having a first end connected to an engine shaft and a second end connected to the second motor; and
a controller configured to:
determine an expected charging power that is expected when a target creep torque is generated through a regenerative braking of the second motor,
discharge a battery by idling the engine with the first motor while the engine clutch is open, and
generate the target creep torque through the regenerative braking of the second motor.

9. The hybrid electric vehicle of claim 8, wherein when the expected charging power is less than a battery charging limit power, the controller is configured to control the idling of the engine not to perform through the first motor.

10. The hybrid electric vehicle of claim 8, wherein the controller is configured to control the first motor to idle the engine in a state where a fuel injection of the engine is prohibited.

11. The hybrid electric vehicle of claim 8, wherein the controller is configured to determine an operating point of the first motor for the idling of the engine when the expected charging power is equal to or greater than a battery charging limit power.

12. The hybrid electric vehicle of claim 11, wherein the controller is configured to determine the operating point of the first motor to consume power in the first motor, and the power is equal to a difference between the expected charging power and the battery charging limit power.

13. The hybrid electric vehicle of claim 8, wherein the target creep torque is determined based on a speed of the vehicle in a state where there is no pedal operation.

14. The hybrid electric vehicle of claim 8, wherein the first motor is connected to the engine shaft, a pulley, and a belt.

15. The hybrid electric vehicle of claim 8, wherein the first motor is directly connected to the engine shaft.
